(19) United States
(12) Patent Application Publication
(10) Pub. No.: US 2017/0001554 A1
(43) Pub. Date: Jan. 5, 2017

(54) Dynamic Warning System

(71) Applicant: BLINDSPOTIT IVS, Skanderborg (DK)

(72) Inventors: Jesper Engelbrekt Sørensen, Glamsbjerg (DK); Søren V. Voigt, Skanderborg (DK)

(21) Appl. No.: 15/105,018

(22) PCT Filed: Dec. 16, 2014
(86) PCT No.: PCT/DK2014/050434

§ 371 Date: Jun. 16, 2016

(30) Foreign Application Priority Data
Dec. 16, 2013 (DK) PA 201300693
Oct. 22, 2014 (DK) PA 201400603

(51) Int. Cl. B60Q 1/52; G08B 5/38; G08G 1/16

(52) U.S. Cl. CPC B60Q 1/525; G08G 1/166; G08B 5/38; B60Q 2400/50; B60Q 2900/10

(57) ABSTRACT

The present invention describes a dynamic warning system suitable to indicate a dangerous area next to a vehicle (1), in particular an area of a road surface in the blind angle (10) of a driver. By illuminating the surface the soft targets (4) will be aware and alerted that attention has to be paid. In practice the illuminated area shall have a sufficient extent such that when the vehicle turns, any object, and in particular any soft target outside the illuminated zone (20) shall be (relatively) safe from coming into contact with the moving vehicle. The warning system comprises:•—a housing suitable to be fastened to or integrated into an exterior surface of a vehicle;•—a light source (5; 30) arranged inside said housing, said light source (5; 30) being capable of emitting sufficient light to illuminate the road surface;•—means (7,11,12;21) for splitting said emitted light into a plurality of distinct light beams, which when projected onto the road surface indicates an area (14;24);•—means for moving the light source relative to the means for splitting the emitted light or vice versa, thereby creating a dynamic warning on said road surface.

### FIELD OF THE INVENTION

The present invention is directed at a dynamic warning system, as well as a method of issuing a warning, in particular to “soft” targets taking part in traffic.

### BACKGROUND OF THE INVENTION

For bicyclists, moped riders and pedestrians, hereinafter referred to as soft targets, the sharing of roads and other traffic lanes with cars, busses and in particular trucks can be particularly dangerous. If soft targets during transport come into contact with a car, bus or truck it will often have severe consequences for the soft targets.

Recently a lot of focus has been put onto a specific problem, namely trucks turning where soft targets, in particular bicyclists are being trapped in a blind angle between the side of the truck and the sidewalk. An area often occupied by bicyclists. Particularly when a truck is stopping for a traffic light, soft targets will proceed up along the inner side of the truck in order to be able to proceed across the intersection when the traffic light turns green again. Particular in this position the truck driver will not be able to see soft targets even though the mirrors usually equipped on trucks etc. aim at providing visibility in this area. In reality the mirrors only provide limited visibility along the side of the truck for the truck driver such that the mirrors provided in various positions in order to try to cover these blind spots, do not sufficiently solve the problem, and still a number of accidents happen particularly in this area. In this connection it is also important to realize that the driver in addition to paying attention to potential soft targets inside the truck also has to pay attention to the rest of the traffic and the intersection as such.

Also in other situations where either the truck or the soft target (bicyclist/pedestrian) or both are moving, such situations arise. A number of these encounters have had fatal consequences for the soft targets, and a number of devices, systems and other actions have been proposed in order to hinder or alleviate these types of accidents. Statistically women have a substantially higher accident rate than men.

Some of these systems include radar or other sensors arranged down the side of the vehicle in order to detect and alert the driver, video cameras installed on the side of the vehicle transmitting information to the driver etc. Common for all these devices are that they put the onus on the driver to exhibit care. Although it is the driver's responsibility to avoid accidents and traffic it would be advantageous to provide systems where the soft targets also become involved. In reality it does not make much difference who has the responsibility or who is to blame. It is typically the soft target who is severely affected by the encounter between the truck and a soft target.

### Definitions

At least within the context of the present invention the following definitions shall be understood:

Pulsating: means that an emitted light varies in intensity. The variation may be from completely extinct to full brightness or anywhere in between.

Dynamic: means that there is movement, for example that the light pattern is not stationary, either by varying the emitted lights intensity, or the position of the emitted light onto the road surface.

Danger zone: is to be understood as an area typically next to a vehicle, such as a truck/lorry, bus or the like, which the driver of the vehicle has great difficulty seeing while manoeuvring the vehicle, typically during turning of the vehicle. For vehicles having the steering wheel in the left side it is typically a problem on the right hand side of the vehicle during right hand turns and vice versa.

Soft targets: is to be understood as persons not being protected, for example by the chassis or bodywork of a car, i.e. bicyclists, scooters, motorbikes, pedestrians etc.

### OBJECT OF THE INVENTION

It is an object of the present invention to provide a solution by which the soft targets are actively alerted to the fact that they are in a blind spot and consequently in a dangerous position.

### DESCRIPTION OF THE INVENTION

The invention addresses this by providing a dynamic warning system suitable to indicate a dangerous area next to a vehicle, in particular an area of a road surface in the blind angle of a driver, where said warning system comprises:
a housing suitable to be fastened to or integrated into an exterior surface of a vehicle;
one or more light sources arranged inside said housing, said light source capable of emitting sufficient light to illuminate the road surface;
means for moving the light source, or means for moving the emitted light, or activating different light sources in a pulsating manner thereby creating a dynamic light pattern or indication warning on said road surface, as set out in claim 1.

By illuminating the surface the soft targets will be aware and alerted that attention has to be paid. In practice the illuminated area shall have a sufficient extent/area such that when the vehicle turns, any object, and in particular any soft target(s) outside the illuminated zone shall be (relatively) safe from coming into contact with the moving vehicle.

As the warning system is provided optionally with its own housing it is possible to retrofit to any vehicle in any appropriate position in the vehicle. In addition to providing warning zone indication for areas where the vehicle may traverse during a turn, the system may also be mounted in positions where passengers may step onto the road surface for example when leaving a bus or for example where ramps and the like used for loading wheel chairs, trollies etc. onto cars or busses. These areas often cause difficulties for the soft targets passing the vehicle.

Furthermore the dynamic feature of the present invention has proven very important. By providing moving or pulsating light patterns in the warning zone the soft target's attention is more readily captured, even for soft targets being preoccupied by mobile phones, music or the like the dynamic light pattern is easy to detect.

Typically these types of accidents to which the present invention presents a solution, arise in built up areas which often have white street markings, such as broad stop lines, pedestrian crossings, hatched areas and the like. The dynamic light emitted by the invention will therefore in many instances be projected onto a white surface, and as such be very easily detected by potential soft targets in the marked zone.

Further advantageous embodiments are set out in the dependent claims, including embodiments as discussed here below.

In a further advantageous embodiment of the invention, means for splitting said emitted light into a plurality of distinct light beams is provided which when projected onto the road surface indicate an area and where means for moving the light source relative to the means for splitting the emitted light or vice versa, creates a dynamic warning on said road surface and optionally that a lens is arranged in the housing in the emitted light's path.

The lens provides the possibility to focus the light and in this manner sharpen the dynamic pattern, which thereby stands out further. Particularly in daylight/sunlight it may be difficult to create a sufficient clear and identifiable pattern. The lens will greatly help to increase the visibility of the pattern and thereby the indication of the warning zone.

The feature of splitting the emitted light provides for a plurality of distinct markings/symbols to be projected onto the road surface from a relatively small and/or simple device. The splitting and/or lens may be controlled individually, such that a number of markings/symbols may be moving at different speeds, in different directions and/or have varying intensity and/or colour.

In a still further embodiment of the invention the system is connected to a source of energy through a relay, in particular the relay controlling the turning signal lights of a vehicle onto which the system is mounted, such that the system is only active when the vehicle's turning signal is active.

This embodiment addresses the issues of indicating and preventing accidents happening when a vehicle is turning. By connecting the warning system to the vehicle's turn off signal, the system will be activated when the driver signals to make a turn. Naturally a further feature may be added where also the speed influences when the signal is activated, as it is only in situations where a turn is to be carried out at low speed the warning zone indication is pertinent.

In a further embodiment the system is remotely activated. This is particularly interesting for warning zones in other places and situations than the turning situation. However, also when the vehicle is turning, a remote activation is interesting. Particularly if the remote activation device is arranged permanently in or close to the turn, the driver will not have to activate the system, but it will be automatically activated as the vehicle approaches the turn. With this embodiment remote activation could be installed in intersections having heavy traffic, at bus stops such that the bus being equipped with the dynamic warning system will alert persons in the vicinity of the bus that for example passengers may disembark and suddenly appear on the road surface, or that people looking to embark may without notice enter the road surface in order to reach the bus.

In a further embodiment of the dynamic warning system the light source is a laser light, optionally a laser light having a power output between 0.5 mW to 50 mW and emitting light having a wave length between 450 and 550 nm or wherein the light source is an LED or halogen or xenon light based light source, preferably emitting light in the red, green and/or white light wave spectre (400 to 800 nm). Generally visible light, particularly blue, green or red light is preferred.

With these light intensities and light sources it is possible to operate the system without affecting the vehicle's general electrical system.

Other sources of light such as LED, halogen, Xenon and the like may also be utilized within the invention, as long as the light source, optionally helped by lenses and the like is able to provide a visible pattern on the road surface next to a vehicle.

In a further preferred embodiment of the dynamic warning system the means for splitting the light beam comprises a number of distinct mirrors mounted on a revolving body, where the plane of the mirrors are mounted at different predetermined angles on/in the body relative to the rotation axis, and where the revolving body is arranged in the light beams path.

In order to create the dynamic warning on the road surface the means for splitting the light beam in a further embodiment comprises a number of distinct mirrors mounted on a revolving body, where the plane of the mirrors are mounted at different predetermined angles on/in the body relative to the rotation axis, and where the revolving body is arranged in the light beam's path or alternatively a diffraction grate is positioned in the light beams path, wherein the grate provides the emitted light in a substantially two dimensional plane, which plane is reflected in a moveable mirror arranged after the diffraction grate, creating a V-shaped light pattern, where the angle between the two legs of the V varies according to the movement of the mirror.

With these rather simple yet robust mechanical systems/constructions, reliable constructions are provided.

It should also be noted that the mount of the light device itself in the housing or the housing's mounting to the vehicle, may be resilient or otherwise moveable, such that the movement of the vehicle itself causes the light to move.

In a further preferred embodiment of the dynamic warning system a flashing light is activated at the same time or prior to the light sources in the housing, where said flashing light is not only or not directed at the road surface.

The purpose of this light, which in reality can be relatively small in size, is to call attention to the vehicle and the dynamic warning symbols on the road surface. Field tests have clearly indicated that a flashing light draws much attention from pedestrians, bicyclists and the like next to a vehicle. Once the soft targets have become aware of the flashing light, they will be more observant and notice the dynamic warning symbols indicating the dangerous area.

In order to further create awareness about the dangerous area the invention in yet another embodiment provides illuminating means, for illuminating the wheel or the wheel arch on the opposite side of the vehicle to the driver's position. The illuminating means may also or additionally be in the shape of a flashing light, optionally shielded towards the surroundings, such that the light flash is only projected onto the road surface.

The invention is also directed at a method for using the dynamic warning system where said method provides a visual warning in a dangerous area next to a vehicle, where said area typically is not directly visible by the driver of said vehicle, where said method includes providing a dynamic warning system as described above on an exterior surface of a vehicle, and at least activating said dynamic warning system below certain vehicle speeds and/or when the vehicle intends to make a turn, and/or when the vehicles turning signal is activated.

### DESCRIPTION OF THE DRAWING

Embodiments of the invention will now be described with reference to the drawing wherein

FIG. 1 illustrates a truck with an indication of the driver's blind angle;

FIG. 2 illustrates the danger zone next to the truck;

FIG. 3, 5 illustrates an embodiment of how to generate a dynamic pattern;

FIG. 4, 6 illustrate a series of moving curves;

FIG. 7, 8 illustrate a further embodiment of a construction

FIG. 9 illustrates a further embodiment

FIG. 10a-d illustrate various patterns

### DETAILED DESCRIPTION

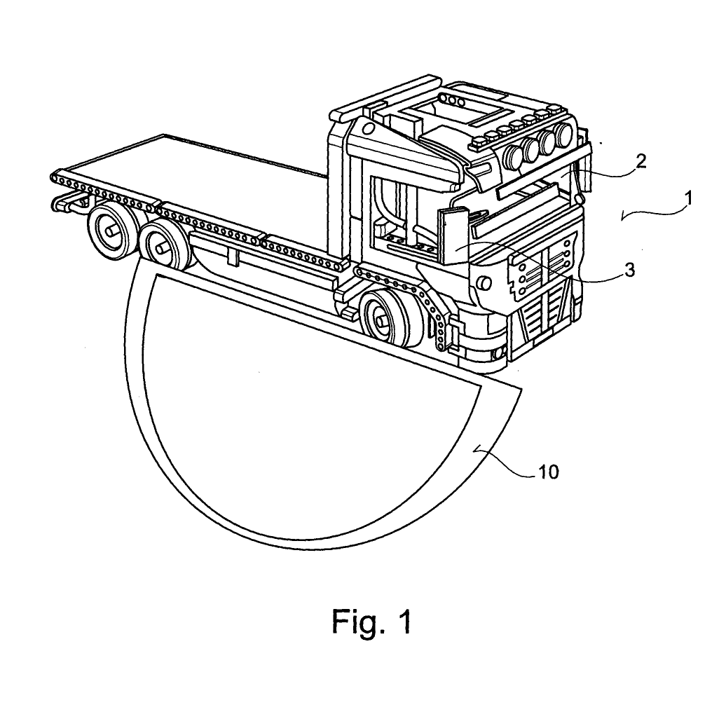

In FIG. 1 is illustrated a truck 1 with an indication of the driver's blind angle, illustrated by the curve 10. Due to the driver's position in the cap 2, even with mirrors 3 mounted in the opposite side, it is very difficult for the driver to see pedestrians, bicyclists etc., also referred to as soft targets placed or positioned inside the curve 10. This area is a danger zone.

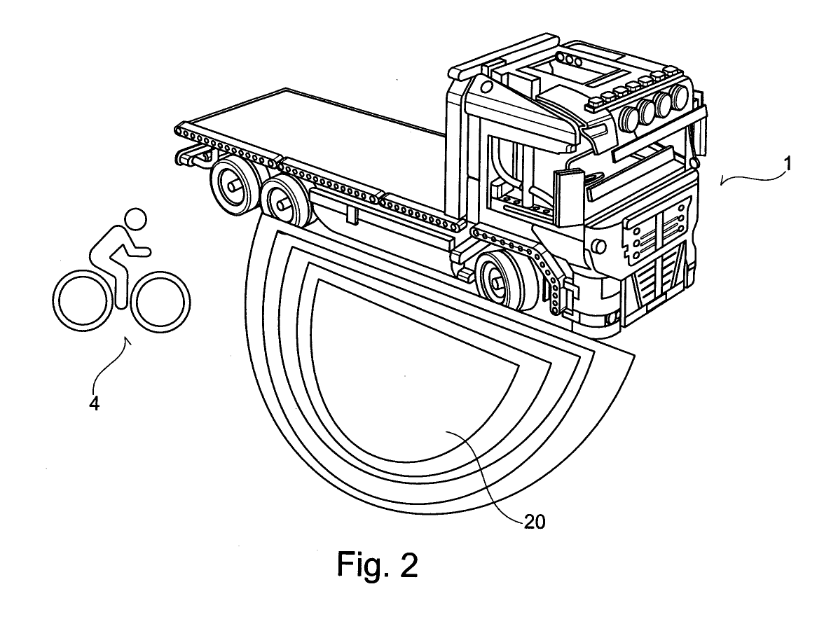

For the purpose of indicating the danger zone and thereby make soft targets (pedestrians, bicyclists, mopeds etc.) aware of the impeding and potential danger, the invention provides a dynamic pattern, as illustrated in FIG. 2. The pattern 20 illuminates the road surface illustrating the danger zone next to the truck 1, such that a soft target, in this example a bicyclist 4 will be aware of the danger zone pattern 20.

The pattern 20 is dynamic, i.e. it pulsates, moves or in other ways is not stationary. It has been found that stationary light indications require a very powerful light source in order to illuminate the road surface sufficiently in order to indicate the danger zone 20, particularly during daylight hours. This on the other hand causes other problems. If the relatively bright light is reflected in water on the road surface the water's surface acts as a mirror, and potentially causes soft targets to look away, temporarily blinded etc. The pulsating or moving pattern 20 on the other hand need not be so bright as by nature the eyes are very good at detecting movement, and as such the dynamic pattern 20 will be detected even unconsciously.

Furthermore the human eye is drawn to movement, even when we are not focusing on the particular item moving. Therefore the dynamic nature of the invention will invariably be noticed by persons in the vicinity of the invention, even though they may not at first realise what the intentions are with the light indications. By selecting the symbols and the colouring of the symbols carefully, for example in the shape of red triangles, red circles with a white bar in the middle and the like, these well-known symbols from ordinary traffic signs will implicitly alert a soft target/person that they should pay attention. As the system becomes more widespread, it will be commonly recognised that the pulsating light areas indicate a dangerous zone.

In order to generate a dynamic pattern various constructions may be contemplated.

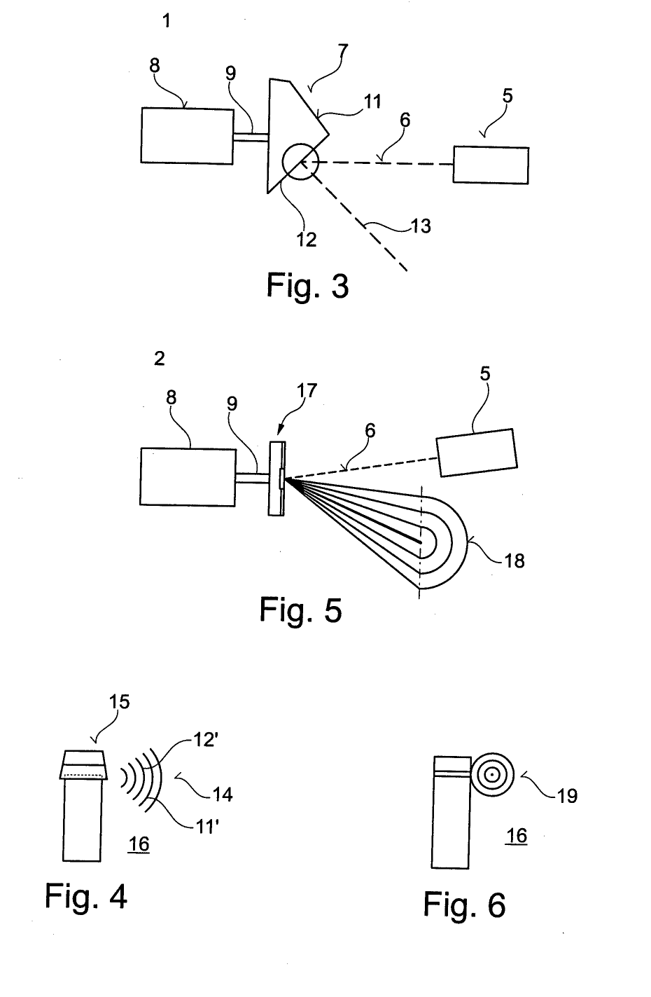

In FIG. 3 is schematically illustrated an embodiment of how to generate a dynamic pattern. A laser 5 is arranged such that it emits a light beam 6 into a rotating body 7. The rotating body 7 is connected to a motor 8, where the motor's axle 9 is rotating around an axis substantially parallel to the light emitting beam 6. The motor's axle is offset from the light emitting direction of the laser 5.

On the rotating body 7 is arranged a number of reflecting elements 11, 12 etc. Each reflecting element 11, 12 etc. is arranged in separate planes such that as each reflecting plane is rotated into the light beam 6, it will reflect the light beam downwards, such that the reflected light beam 13, continuously will move on the plane on which it is projected. Typically the plane (not illustrated) will be a road surface in the vicinity of a vehicle 15. The reflected pattern 14 will typically, as illustrated in FIG. 4 be a series of moving curves. The reflected light beam 13 will project a point onto the surface 16, and due to the rotation of the rotating body 7, the light point will describe a curve 11′. As the rotating body 7 continues to rotate, the next reflecting element 12 reflects the light beam 6. As the reflecting element is arranged at a different angle relative to the rotation axis compared to the other reflecting elements the reflected light beam 13 will describe a different curve 12′. Due to the rotation speed of the rotating body 7 the reflected light points will be conceived as curves 11′, 12′ etc. The number of curves is directly corresponding to the number of reflecting elements 11, 12 being passed through the light beam 6.

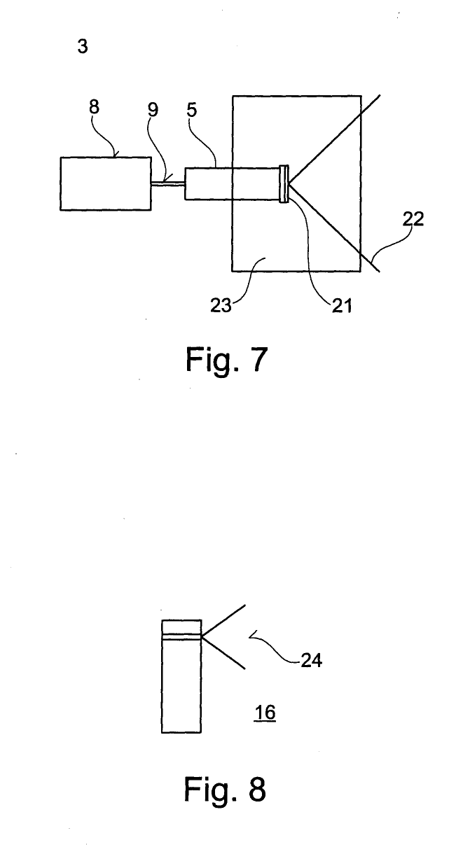

In FIGS. 7 and 8 is illustrated a further embodiment of a construction which provides a further dynamic pattern on a road surface 16. The light device 5, in this case also a laser, is mounted on the axle 9 of a motor 8. As the axle rotates the laser 5 will also rotate. In front of the laser 5 is arranged a diffraction grating 21 which alters the emitted light into a two dimensional light plane 22. The light plane 22 is bounced off a reflective surface 23 which in the illustrated embodiment is substantially plane, but in other embodiments may be curved, convex or concave.

As the light plane 22 is rotated and reflected by the reflecting surface 23 onto a road surface, a moving V shaped light pattern 24, see FIG. 8, is created and displayed on the road surface. The distal ends of the two “legs” of the V will move towards each other and away from each other, sweeping the danger zone.

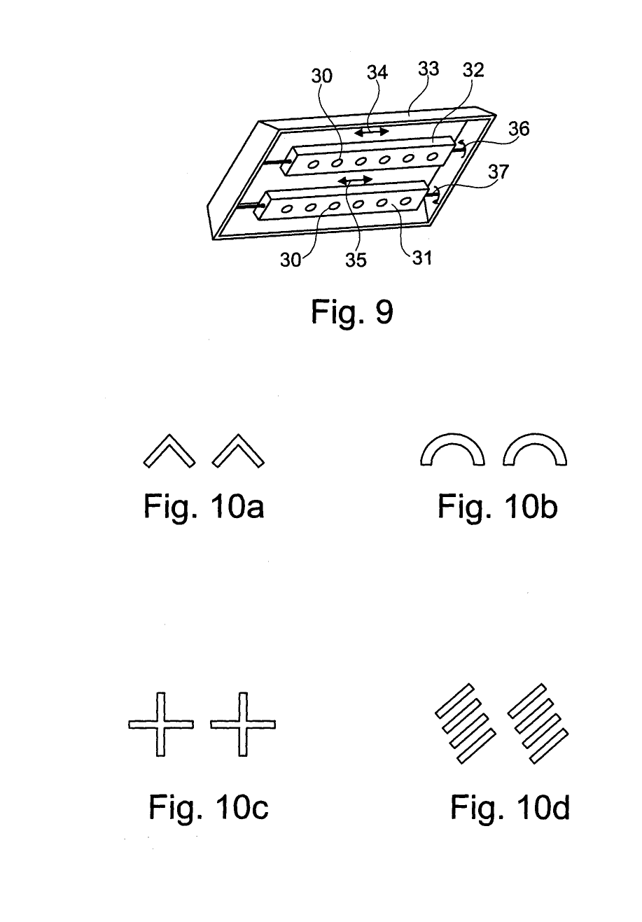

In a further example, illustrated in FIG. 9, a number of LED lights 30 are arranged on one or more bars, in the illustrated example two bars 31, 32 inside the housing 33. The bar(s) may oscillate such that the LEDs (or other light sources) mounted on the bar will be moved back and forth, as indicated by the arrows 34, 35 relative to the housing 33. The bars 31, 32 may also be rotated, for example back and forth around the axles 36, 37. The emitted light will therefore move on the road surface in a pattern back and forth, for example perpendicular to the side of the vehicle. By furthermore turning on and off the individual light sources the pattern projected onto the road surface will have great variation.

Light sources may also be mounted in a grid-like arrangement, and by controlling which individual light sources are emitting light, a dynamic pattern is created/projected onto the road surface.

In FIG. 10a-d is illustrated various patterns which may be projected onto the road surface. These are only examples, as any design may be selected and used.

Although the invention above has been explained with reference to the blind angle/area of a truck or lorry, the invention may also be used in order to indicate areas alongside a bus where passengers leaving the bus may step onto the road surface, or behind handicap transports where a ramp or the like will be lowered or wheelchair lifts may be activated etc.

The system may be activated in a number of different manners. For example when the system is mounted on a truck, the system may be activated by the truck's signal indicating the intention to make a turn. Typically it will also be coupled with a speed indicator, in order to make sure the system is only activated under certain relatively low speeds.

The system may also be activated by a remote device, for example operated by the chauffeur. The remote activating device may also be mounted in the vicinity of wellknown spots where the type of turning accidents are likely to occur, such that as vehicles approach these locations the system is turned on.

1. Dynamic warning system suitable to indicate a dangerous area next to a vehicle, in particular an area of a road surface in the blind angle of a driver, where said warning system comprises:
a housing suitable to be fastened to or integrated into an exterior surface of a vehicle;
one or more light sources arranged inside said housing, said light source capable of emitting sufficient light to illuminate the road surface;
means for moving the light source, or means for moving the emitted light, or activating different light sources in a pulsating manner thereby creating a dynamic light pattern or indication warning on said road surface.

2. The dynamic warning system according to claim 1, wherein means for splitting said emitted light into a plurality of distinct light beams, which when projected onto the road surface indicates an area and where means for moving the light source relative to the means for splitting the emitted light or vice versa, creates a dynamic warning on said road surface and optionally that a lens is arranged in the housing in the emitted lights path.

3. The dynamic warning system according to claim 1 wherein the system is connected to a source of energy through a relay, in particular the relay controlling the turning signal lights of a vehicle onto which the system is mounted, such that the system only is active when the vehicle's turning signal is active.

4. The dynamic warning system according to claim 1 wherein the system is remotely activated.

5. The dynamic warning system according to claim 1 wherein the light source is a laser light, optionally a laser light having a power output between 0.5 mW to 50 mW and emitting light having a wave length between 450 and 550 nm or wherein the light source is an LED or halogen or xenon light based light source, preferably emitting light in the red, green and/or white light wave spectre.

6. The dynamic warning system according to claim 2, wherein the means for splitting the light beam comprises a number of distinct mirrors mounted on a revolving body, where the plane of the mirrors are mounted at different predetermined angles on/in the body relative to the rotation axis, and where the revolving body is arranged in the light beams path.

7. The dynamic warning system according to claim 1 wherein a flashing light is activated at the same time or prior to the light sources in the housing, where said flashing light is not only or not directed at the road surface.

8. The dynamic warning system according to claim 1 wherein illuminating means are provided for illuminating the wheel or the wheel arch on the opposite side of the vehicle to the driver's position.

9. Method of providing a visual warning in a dangerous area next to a vehicle, where said area typically is not directly visible by the driver of said vehicle, where said method includes providing a dynamic warning system according to claim 1 on an exterior surface of a vehicle, and at least activating said dynamic warning system below certain vehicle speeds and/or when the vehicle intends to make a turn, and/or when the vehicle's turning signal is activated.
